(19) United States
(12) Patent Application Publication
(10) Pub. No.: US 2005/0038694 A1
(43) Pub. Date: Feb. 17, 2005

(54) System and method of extracting solutions and implementation program thereof

(76) Inventors: Hitoshi Kobara, Saitama (JP); Hideaki Nakao, Kagoshima (JP)

Correspondence Address: MORRISON & FOERSTER LLP, 1650 TYSONS BOULEVARD, SUITE 300, MCLEAN, VA, 22102, US

(21) Appl. No.: 10/898,561

(22) Filed: Jul. 26, 2004

(30) Foreign Application Priority Data
Aug. 1, 2003 (JP) 2003-285114

(51) Int. Cl. G06F 17/60

(52) U.S. Cl. 705/10

(57) ABSTRACT

System and method of automatically extracting solutions suitable for customer's requests without necessity of staffs having accumulated knowledge and experience are disclosed. The system includes a terminal and a server apparatus. The server apparatus has an input screen formation part forming an input screen, which includes a plurality of object items and a predetermined number of choices for request intensity levels associated with each object item, and a database having fitness values associated with each object item for each solution. The server apparatus, in response to receipt of the request intensity levels associated with object items from the terminal, extracts suitable solutions based on the received request intensity levels and the fitness value associated with the object items registered in the database.

### BACKGROUND OF THE INVENTION

1. Field of the Invention

The present invention generally relates to system and method of extracting suitable solutions, for example, in response to requests from customers. More particularly, the present invention relates to system and method of automatically extracting solutions suitable for a plurality of objects based on respective priorities.

2. Description of the Related Art

As disclosed in Japanese Laid-Open Patent Application No. 2002-222306, sales assistance methods, server apparatuses and implementation programs thereof have been proposed for informing sales staffs of desired goods and customer information on customers, for example, when commodity information is provided over Web pages and the customers select the desired goods via the Web pages.

Also, as disclosed in Japanese Laid-Open Patent Application No. 2002-288550, sales assistance systems have been proposed to generate customer marketing information based on customer access history information to Web sites and stored customer information and allow sales staffs to use or view the generated customer marketing information via terminals.

Conventionally, for example, when a sales staff attempts to sell office equipment, the sales staff visits a customer and listens to potential needs of the customer. Based upon the caught needs, the sales staff proposes a solution, for example, a suitable machine, to the customer. However, the ability of quickly proposing such an appropriate solution largely depends on accumulated knowledge and experience of the sales staff. Thus, a sales company is highly difficult to employ a large number of such well-informed and well-experienced staffs.

On the other hand, the Internet has been widely used for sales activity. As seen in the above-mentioned disclosure, there are some sales assistance methods in which when a customer can often select desired goods via the Internet, a sales staff make sales based on the selection. However, the disclosed conventional techniques cannot necessarily provide the customer with suitable solutions based on the selection. According to the disclosed techniques, sales staffs are required to have enough knowledge and experience in order to derive such suitable solution based on the selection.

### SUMMARY OF THE INVENTION

It is a general object of the present invention to provide a solution extraction system, a solution extraction method, and a recording medium for storing a solution extraction program in which one or more of the above-mentioned problems are eliminated.

A more specific object of the present invention is to provide a solution extraction system, a solution extraction method, and a recording medium for storing a solution extraction program that can automatically extract solutions suitable for customer's requests without necessity of staffs having a rich amount of accumulated knowledge and experience.

In order to achieve the above-mentioned objects, there is provided according to one aspect of the present invention a system for extracting a solution, including: a terminal having a display part and an input part; and a server apparatus being connected to the terminal via a network, the server apparatus having an input screen formation part and a database, the input screen formation part forming an input screen including a plurality of object items and a predetermined number of choices for request intensity levels associated with the plurality of object items, the database being configured such that at least one fitness value is associated with each of the plurality of the object items for each of a plurality of solutions, wherein the server apparatus sends the input screen to the terminal, and in response to receipt of the request intensity levels associated with one or more object items designated by the input part of the terminal, the server apparatus extracts one or more suitable solutions from the plurality of solutions based on the received request intensity levels and the at least one fitness value associated with the one or more object items registered in the database.

According to one aspect of the present invention, it is possible to provide a solution extraction system that can automatically extract solutions suitable for customer's requests without necessity of staffs having a rich amount of accumulated knowledge and experience.

In an embodiment of the present invention, the server apparatus may associate a weight value with each of the request intensity levels, in response to receipt of the request intensity levels associated with the one or more object items designated by the input part of the terminal, for each of the one or more object items, multiply the weight value associated with the respective request intensity level by the corresponding fitness value registered in the database, compute a sum of the multiplied products corresponding to the one or more object items for each of the plurality of solutions, and extract the one or more suitable solutions from the plurality of solutions in ascending order with respect to the sums corresponding to the plurality of solutions.

According to one aspect of the present invention, it is possible to obtain suitable solutions through easy computation.

In an embodiment of the present invention, the system may further include: a reset part resetting the fitness values associated with the plurality of object items registered in the database.

According to one aspect of the present invention, it is possible to obtain suitable solutions corresponding to change of situations.

In an embodiment of the present invention, the reset part may reset the fitness values depending on whether the extracted one or more solutions have been accepted.

According to one aspect of the present invention, it is possible to obtain suitable solutions responsive to customer's intention.

In an embodiment of the present invention, the server apparatus may include a proposal screen formation part forming a proposal screen including the extracted one or more solutions and choices for accepting the corresponding extracted solutions, and when the server apparatus sends the proposal screen to the terminal and the terminal adopts the extracted one or more solutions, the reset part may reset the fitness values in such a way that the acceptance is reflected.

According to one aspect of the present invention, it is possible to automatically reset the fitness values and obtain suitable solutions responsive to customer's intention.

In an embodiment of the present invention, the reset part may reset the fitness values based on deviation scores.

According to one aspect of the present invention, it is possible to obtain suitable solutions responsive to customer's intention without dependency on extraction frequency.

In an embodiment of the present invention, the reset part may compute standard deviations at time of resetting the fitness values, and when any of the standard deviations is not less than or equal to a predetermined value, the server apparatus may call an alert.

According to one aspect of the present invention, it is possible to prevent inappropriate solution extraction due to dispersion of preference of whole customers.

Additionally, there is provided according to another aspect of the invention a method of extracting a solution, including steps of: constructing a database in such a way that at least one fitness value is associated with each of a plurality of object items for each of a plurality of solutions; forming an input screen including the plurality of object items and a predetermined number of choices for request intensity levels associated with the plurality of object items; sending the input screen to a terminal and displaying the input screen on a displaying part of the terminal; extracting, in response to receipt of request intensity levels associated with one or more object items designated by an input part of the terminal, one or more suitable solutions from the plurality of solutions based on the received request intensity levels and the at least one fitness value associated with the one or more object items registered in the database.

According to one aspect of the present invention, it is possible to provide a solution extraction method that can automatically extract solutions suitable for customer's requests without necessity of staffs having a rich amount of accumulated knowledge and experience.

Additionally, there is provided according to another aspect of the invention a recording medium for storing a program to cause a computer to execute a procedure of extracting a solution for a system having a terminal and a server wherein the terminal includes a display part and an input part and a server apparatus is connected to the terminal via a network and includes a database configured such that at least one fitness value is associated with each of the plurality of the object items for each of a plurality of solutions, the procedure including steps of: forming an input screen including the plurality of object items and a predetermined number of choices for request intensity levels associated with the plurality of object items; sending the input screen to the terminal and displaying the input screen on the displaying part of the terminal; extracting, in response to receipt of request intensity levels associated with one or more object items designated by the input part of the terminal, one or more suitable solutions from the plurality of solutions based on the received request intensity levels and the at least one fitness value associated with the one or more object items registered in the database.

According to one aspect of the present invention, it is possible to provide a solution extraction program that can automatically extract solutions suitable for customer's requests without necessity of staffs having a rich amount of accumulated knowledge and experience.

Other objects, features and advantages of the present invention will become more apparent from the following detailed description when read in conjunction with the accompanying drawings.

### BRIEF DESCRIPTION OF THE DRAWINGS

FIG. 1 is a block diagram illustrating an exemplary structure of a solution extraction system according to an embodiment of the present invention;

FIGS. 2A through 2E show exemplary screens displayed on a terminal of a system according to an embodiment of the present invention;

FIGS. 3A through 3C show exemplary data structures of a proposal master, a product master and a customer master, respectively, according to an embodiment of the present invention;

FIG. 4 shows exemplary relationship between the proposal master and the product master according to an embodiment of the present invention;

FIG. 5 is a flow diagram illustrating an exemplary overall process of a system according to an embodiment of the present invention; and

FIG. 6 is a flow diagram illustrating an exemplary reevaluation process of a system according to an embodiment of the present invention.

### DETAILED DESCRIPTION OF THE PREFERRED EMBODIMENTS

In the following, embodiments of the present invention will be described with reference to the accompanying drawings.

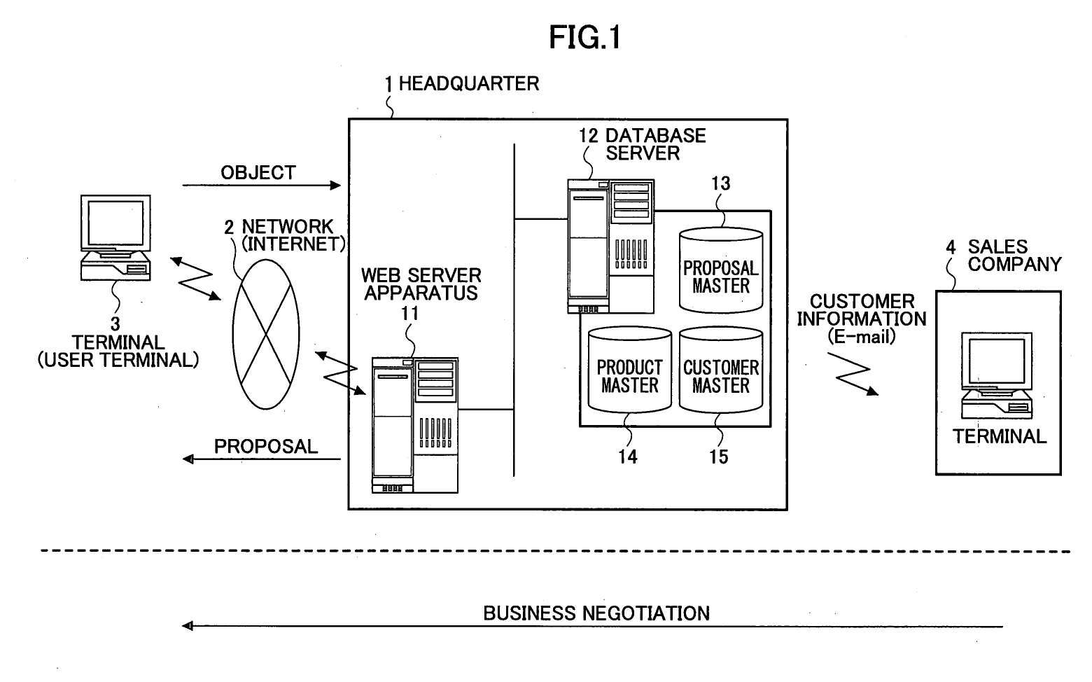

FIG. 1 is a block diagram illustrating an exemplary system structure of a system to which the present invention is applied.

Referring to FIG. 1, a head office 1 of a company manufacturing one or more products is provided with a Web server apparatus 11 connected to a network 2 such as the Internet. The Web server 11 introduces the head office 1 and distributes prodcut information via the network 2. In response to access to the Web server apparatus 11 from a terminal (user terminal) 3 via the network 2, the above information is displayed on a display part of the terminal 3.

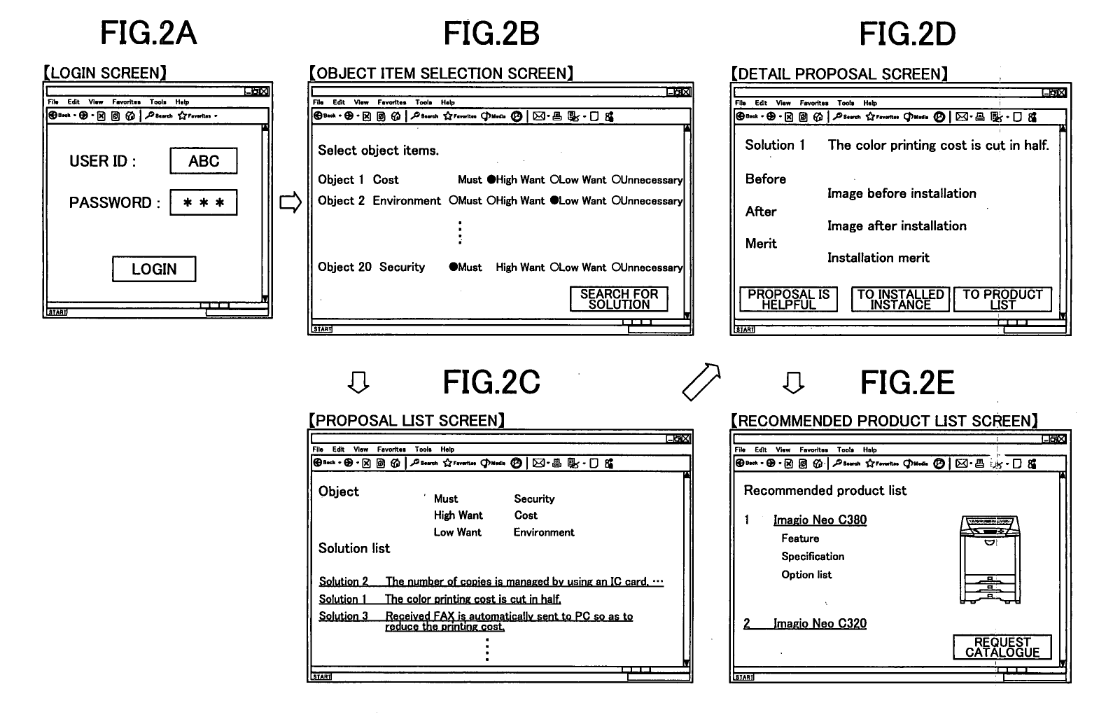

In order to obtain solutions corresponding to requests, the customer manipulates an input part of the terminal 3 in a predetermined manner. In response to the manipulation, a login screen, as shown in FIG. 2A, is displayed on the display part of the terminal 3. It is noted that a user is required to supply a user ID and a password so that only registered users can use such a service. The user can use the input part of the terminal 3 to supply the user ID and the password.

In response to receipt of the user ID and the password, the terminal 3 sends such input information to the Web server apparatus 11 via the network 2. Once the Web server accepts the input information, the Web server apparatus 11 generates an object selection screen, for example, as shown in FIG. 2B, and sends the generated screen to the terminal 3 via the network 2. In response to receipt of the object selection screen, the terminal 3 displays the received screen on the display part thereof. For example, this screen includes 20 object items and four levels of request intensity corresponding to the respective object items.

For example, as illustrated in FIG. 2B, these four levels of request intensity are represented as “Must”, “High Want”, “Low Want” and “Unnecessary” in the intensity order. In the illustrated object selection screen, the user selects one of the four levels for each object item by using the input part such as a mouse so as to supply the request intensity for the individual object items. After the input, if the user clicks the mouse on the illustrated “SEARCH FOR SOLUTION” button, the supplied request intensity information is sent to the Web server apparatus 11 via the network 2.

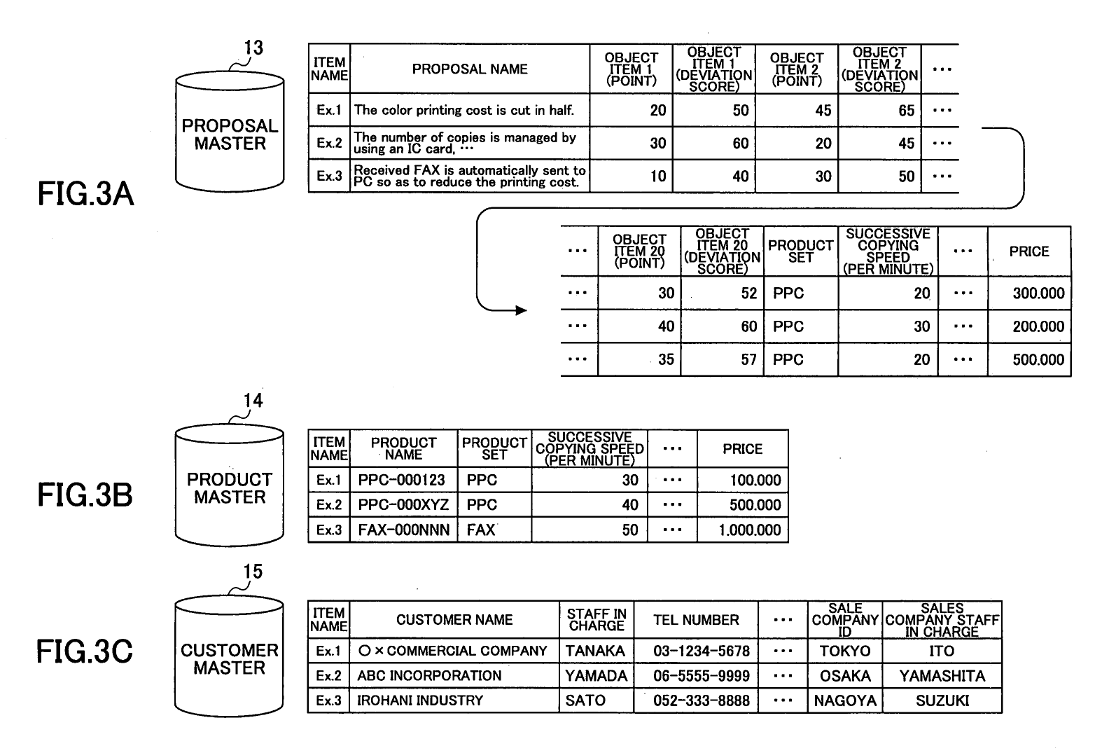

Also, as shown in FIG. 1, a database server 12 is connected to the Web server apparatus 11. The database server 12 at least includes a proposal master 13, a product master 14 and a customer master 15. In the proposal master 13, for example, tens of thousands of proposals are registered. For each proposal, as shown in FIG. 3A, the above-mentioned 20 object items have respective points and deviation scores, which are used as respective fitness values. Additionally, product information associated with each proposal, such as specification and price, may be provided to the proposal master 13.

Based upon the received request intensity information on the object items, the Web server apparatus 11 extracts one or more suitable solutions in accordance with the preset values in the database server 12.

Specifically, the solutions can be extracted as follows. First, weight values 3 through 0 are assigned to the four request intensity levels, respectively. In addition, for each proposal registered in the proposal master 13, the weight values corresponding to the designated request intensity levels are multiplied by the preset points of the individual object items, and the resulting products are summed. One or more upper-pointed proposals are extracted in the ascending order of respective summed values of the registered proposals. These solutions are supplied to the customer as solutions that respond to the request intensity levels of the individual object items given by the customer.

For example, it is supposed that the customer designates the request intensity of object items 1, 2 and 20 as “High Want” (weight value “2”), “Low Want” (weight value “1”) and “Must” (weight value “3”), respectively, in the input screen shown in FIG. 2B. In this case, for example, since the proposal Ex.1 of the proposal master 13 shown in FIG. 3A has deviation scores 50, 65 and 52 associated with the object items 1, 2 and 20, respectively, the product sum of the proposal Ex.1 is calculated as 321 (=2×50+1×65+3×52).

In similar computation, since the proposal Ex.2 has deviation scores 60, 45 and 60 associated with the object items 1, 2 and 20, respectively, the product sum of the proposal Ex.2 is equal to 345. (=2×60+1×45+3×60). Also, since the proposal Ex. 3 has deviation scores 40, 50 and 57 associated with the object items 1, 2 and 20, respectively, the product sum of the proposal Ex.3 is equal to 301 (=2×40+1×50+3×57). Among the proposals Ex. 1 through Ex.3, the proposal Ex.2 having the greatest product sum 345 is proposed as the most suitable solution, and further the proposals Ex.1 and Ex.3 having the respective product sums 321 and 301 may be extracted in that order.

It is noted that the above computation is actually performed for every of the tens of thousands of proposals registered in the proposal master 13 and some number of upper-pointed proposals may be extracted. As a result, a proposal list screen, as shown in FIG. 2C, can be displayed on the display part of the terminal 3. In the upper part of this screen, the selected object items are displayed in the ascending order of the request intensity level. In the lower part of the screen, solutions suitable to the supplied request are displayed. In this case, Ex.2, Ex.1 and Ex. 3 are displayed as “Solution 2”, “Solution 1” and “Solution 3” in that extraction order.

In addition, each “Solution” item is linked to an address, and in response to clicking on the item, a detail proposal screen, as shown in FIG. 2D, may be displayed. In the illustration, the item “Solution 1” has been clicked. In this screen, the selected “Solution” item is shown in detail. In addition, some buttons: “PROPOSAL IS HELPFUL”, “TO INSTALLED INSTANCE” and “TO PRODUCT LIST” are provided in the lower part of the screen. If the button “TO INSTALLED INSTANCE” is clicked, some previously installed instances are presented.

On the other hand, if the button “TO PRODUCT LIST” is clicked, a recommended product list screen, as shown in FIG. 2E, is displayed. In this screen, product information, such as a product image, features, specification and a list of optional parts, of a product registered in the product master, as shown in FIG. 3B, associated with the proposal may be displayed. In addition, for example, a button “REQUEST CATALOGUE” is provided in the lower part of the screen, and in response to clicking on the button “REQUEST CATALOGUE”, information from the customer master 15, as shown in FIG. 3C, is e-mailed to the sales company 4 shown in FIG. 1.

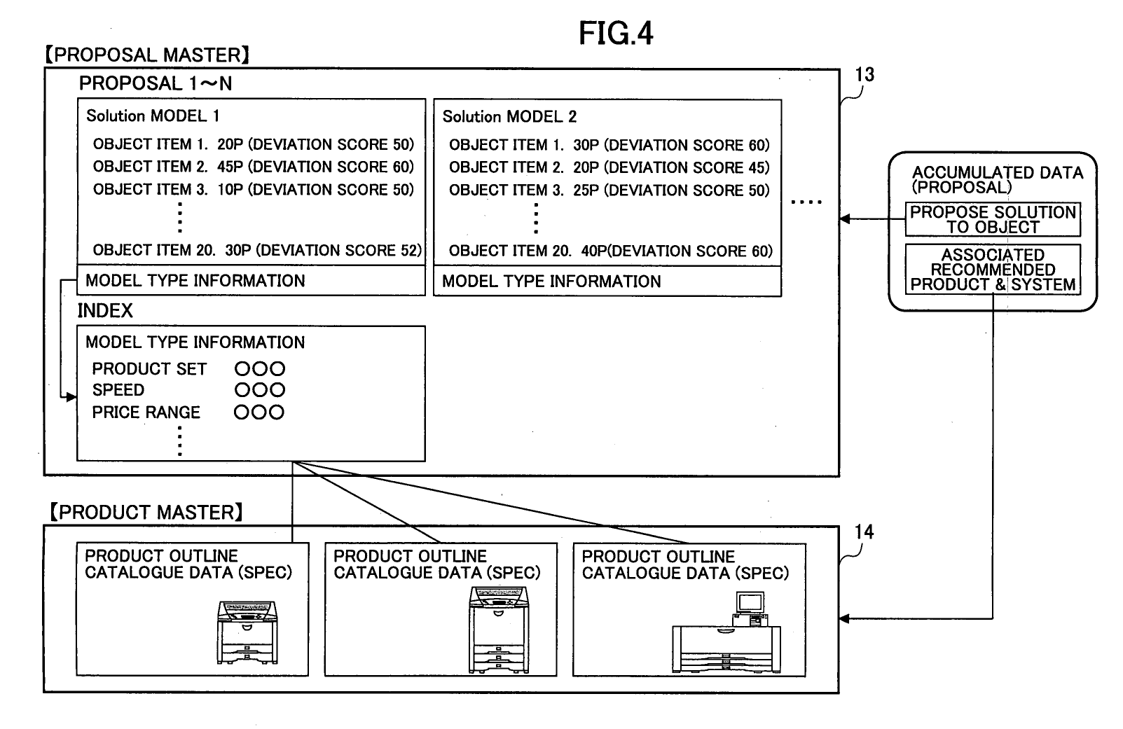

FIG. 4 shows exemplary relationship between the proposal master 13 and the product master 14. Based upon accumulated proposal documents, some proposals, such as Solution model 1 and Solution model 2 shown in FIG. 4, are registered in the proposal master 13, and the above-mentioned points and deviation scores are set for individual object items of each proposal. Also, these proposal documents include data such as product types of actually introduced products, and the corresponding product type information is attached as Index shown in FIG. 4.

On the other hand, information on recommended products and systems associated with the proposal documents is registered in the product master 14, and the information may include product images as well as summary and catalogue data (specification). For an extracted proposal as mentioned above, information on recommended products or systems can be selected from the product master 14 corresponding to an index of associated product type information in the proposal master 13. In this manner, a recommended product or system can be selected in association with the extracted proposal.

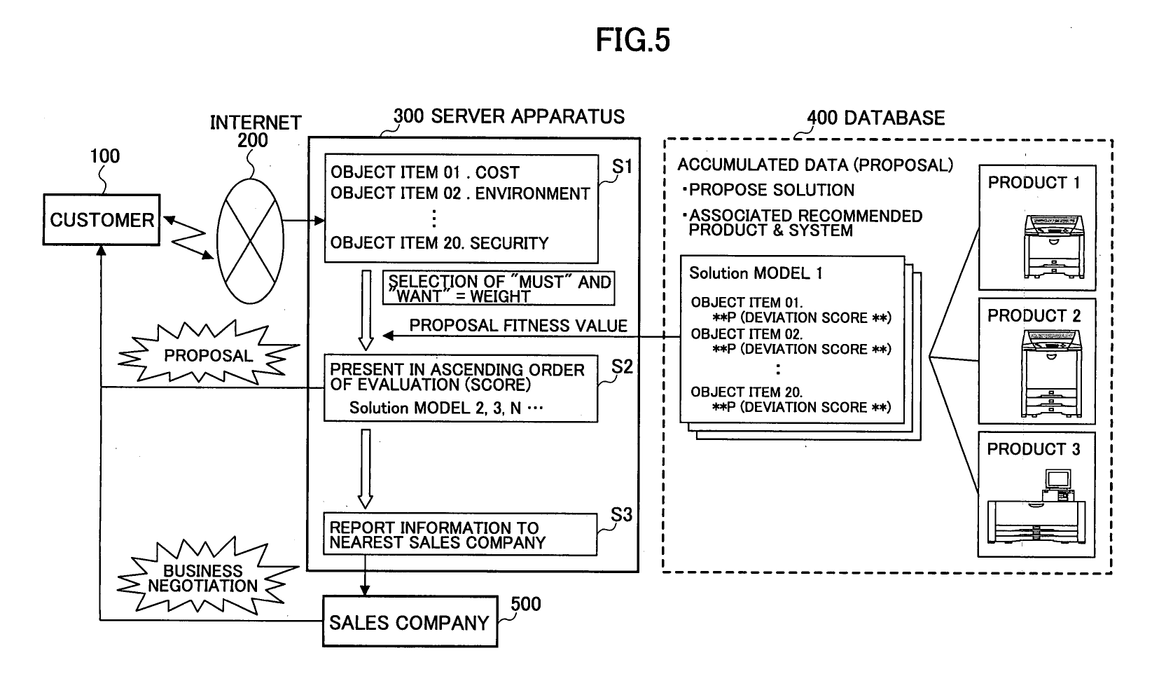

FIG. 5 is a diagram illustrating an exemplary whole process flow according to an embodiment of the present invention.

Referring to, FIG. 5, a customer 100 accesses a server apparatus 300 from an arbitrary terminal via the Internet 200. At step S1, the server apparatus 300 receives the request intensity level of individual object items supplied from the customer 100. At step S2, some proposals are presented to the customer 100 in the ascending order with respect to evaluation scores computed from weight values corresponding to the request intensity levels and fitness values in the database 400.

At step S3, the information is reported to the nearest sales company 500. Based upon information (sales company ID) registered in the customer master 15, the information is sent to the sales company 500. The reported information includes one or more objects designated by the customer 100 and proposal contents extracted corresponding to the objects, as well as the company name, the name of a person in charge and a telephone number of the customer 100 and a name of a sales staff in charge of the sales company 500. As a result, the sales company 500 dispatches the sales staff in charge to the customer 100, and thereby can launch quick deal and business.

According to the above-mentioned embodiment, an input screen is generated for selecting a plurality of object items and designating the respective request intensity levels. Based upon the request intensity levels of the individual object items supplied from the customer 100 and fitness values associated with the object items registered in the database, one or more suitable solutions can be extracted from a plurality of registered solutions and be presented to the customer 100. As a result, it is possible to automatically extract such one or more solutions suitable for customer requests without dependency on accumulated knowledge and experience.

Conventionally, in order to quickly present a solution suitable for a customer request to a customer, sales staffs are required to have a large amount of knowledge and experience. Thus, in order to successfully carry on business, a sales company needs a large number of well-informed and well-experienced staffs. According to the present invention, however, it is possible to easily eliminate such problems.

In the above-mentioned embodiment, fitness values corresponding to individual object items are preset in a database. Typically, these fitness values may be manually determined, for example, by holding an evaluation meeting composed of well-informed and well-experienced staffs. However, the fitness values determined in such a way are not absolutely correct. Also, since the fitness values are determined responsive to preference and other factors of whole customers, there is a possibility that the fitness values may be corrected, for example, depending on change of social situation and trend.

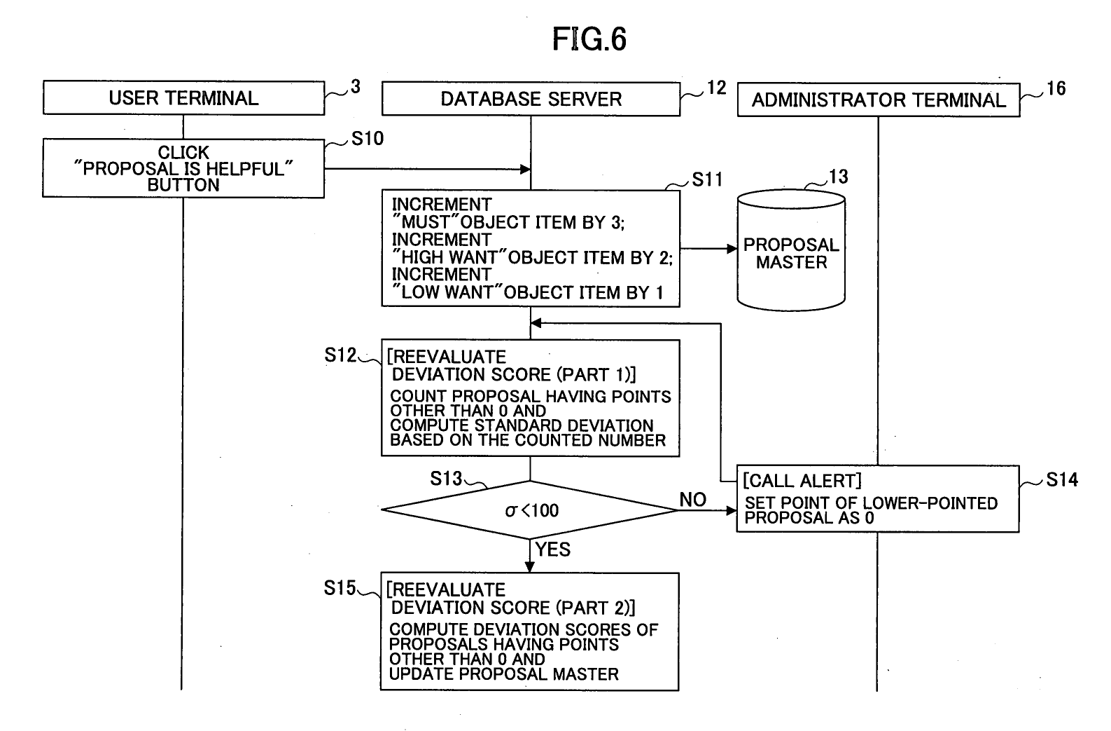

In the above-mentioned embodiment of the present invention, means for automatically resetting the fitness values depending on preference and other factors of whole customers may be further provided. Specifically, the button “PROPOSAL IS HELPFUL” is provided in the lower part of the detail proposal screen shown in FIG. 2D, and when the button is clicked, it is determined that the presented proposal is suitable for the customer request. Based upon the determination, the fitness values are automatically updated in accordance with an exemplary flowchart in FIG. 6.

Referring to FIG. 6, when the button “PROPOSAL IS HELPFUL” is clicked in the terminal 3 at step S10, for one or more relevant proposals, the current point of one or more object items designated as “Must” by the customer is incremented by 3 in the database server 12 at step S11. In addition, the current point of one or more object items designated as “High Want” is incremented by 2, and the current point of one or more object items designated as “Low Want” is incremented by 1. Then, the updated proposal is stored in the proposal master 13.

At step S12, the standard deviation σ is computed for proposals having points other than 0 in relevant proposals in accordance with the following formula;

$$σ = \sqrt{\frac{{\sum }_{i = 1}^{n} {( {measured\_value}_{i} - average\_value )}^{2}}{n}} ,$$

where n is the number of proposals having other than 0 in the relevant proposals.

At step S13, it is determined whether the computed standard deviation a is less than or equal to 100. If σ is not less than or equal to 100 (S13: No), an alert is sent to an administrator terminal 16 (not shown in FIG. 1) at step S14. Then, the points of lower-pointed proposals are made 0 in the administrator terminal 16, and the process control returns to step S12 in the database server 12. Then, this process is repeated until the standard deviation σ is less than or equal to 100.

On the other hand, once the standard deviation σ is less than or equal to 100 (S13: Yes), the proposal master 13 is updated by computing deviation scores for data items having values other than 0. It is noted that the deviation score ds is computed as follows;
ds=(measured_value−average_value)/σ×10+50.
In this manner, the point and the deviation score, which collectively serve as the fitness value in the proposal master 13, can be reset.

According to this embodiment, it is possible to automatically reset the fitness values responsive to change of preference and other factors of whole customers. It is noted that the upper bound of the standard deviation is limited, that is, the large standard deviation is ignored at step S13 in consideration of large dispersion with respect to preference of whole customers. Also, lower-pointed data items are made 0 so as to exclude unnecessary solutions as solutions that should not be extracted for a given object. This exclusion can make the standard deviation an appropriate value by reducing the number n of data items.

It will be understood by those skilled in the art that the present invention is not limited to the above-mentioned specific embodiments such as product sales. For example, the present invention is applicable to extraction of suitable human resource for personnel service companies. In this case, the present invention can efficiently extract human resources desired by companies based on request intensity such as “Must” and “Want” associated with individual categories, for example, a foreign language skilled person and a PC skilled person. If such selected human resources are appropriately reevaluated as in the above-mentioned embodiments, it is possible to improve management of the human resources, for example, to increase possibility that presented human resources may be accepted by other companies.

Alternatively, the present invention is applicable to a method of presenting suitable solutions in so-called FAQ/call centers in response to various questions. In this case, as a solution is frequently presented, the corresponding point increases, thereby raising the displaying rank of the solution. As a result, users can find the solution quickly. In this manner, the present invention can be used for FAQ or answering systems such as call centers.

The present invention may be implemented in software by causing a computer to execute a solution extraction program. Typically, such a program for implementing the present invention can be stored in a computer-readable recording medium. Common forms of computer-readable media include, for example, a floppy disk, a flexible disk, a hard disk, a magnetic tape, a CD-ROM, or any other medium from which a computer can read data.

In alternative embodiments, hardware may be used in place of or in combination with the software programs.

The present invention is not limited to the specifically disclosed embodiments, and variations and modifications may be made without departing from the scope of the present invention.

The present application is based on Japanese Patent Priority Application No. 2003-285114 filed Aug. 1, 2003, the entire contents of which are hereby incorporated by reference.

1. A system for extracting a solution, comprising:
a terminal having a display part and an input part; and
a server apparatus being connected to the terminal via a network, said server apparatus having an input screen formation part and a database, said input screen formation part forming an input screen including a plurality of object items and a predetermined number of choices for request intensity levels associated with each of the plurality of object items, said database being configured such that at least one fitness value is associated with each of the plurality of the object items for each of a plurality of solutions,
wherein said server apparatus sends the input screen to the terminal, and in response to receipt of the request intensity levels associated with one or more object items designated by the input part of the terminal, the server apparatus extracts one or more suitable solutions from the plurality of solutions based on the received request intensity levels and the at least one fitness value associated with the one or more object items registered in the database.

2. The system as claimed in claim 1, wherein the server apparatus associates a weight value with each of the request intensity levels, in response to receipt of the request intensity levels associated with the one or more object items designated by the input part of the terminal, for each of the one or more object items, multiplies the weight value associated with the respective request intensity level by the corresponding fitness value registered in the database, computes a sum of the multiplied products corresponding to the one or more object items for each of the plurality of solutions, and extracts the one or more suitable solutions from the plurality of solutions in ascending order with respect to the sums corresponding to the plurality of solutions.

3. The system as claimed in claim 1, further comprising:
a reset part resetting the fitness values associated with the plurality of object items registered in the database.

4. The system as claimed in claim 3, wherein the reset part resets the fitness values depending on whether the extracted one or more solutions have been accepted.

5. The system as claimed in claim 4, wherein the server apparatus comprises a proposal screen formation part forming a proposal screen including the extracted one or more solutions and choices for accepting the corresponding extracted solutions, and when the server apparatus sends the proposal screen to the terminal and the terminal adopts the extracted one or more solutions, the reset part resets the fitness values in such a way that the acceptance is reflected.

6. The system as claimed in claim 4, wherein the reset part resets the fitness values based on deviation scores.

7. The system as claimed in claim 6, wherein the reset part computes standard deviations at time of resetting the fitness values, and when any of the standard deviations is not less than or equal to a predetermined value, the server apparatus calls an alert.

8. A method of extracting a solution, comprising steps of:
constructing a database in such a way that at least one fitness value is associated with each of a plurality of object items for each of a plurality of solutions;
forming an input screen including the plurality of object items and a predetermined number of choices for request intensity levels associated with each of the plurality of object items;
sending the input screen to a terminal and displaying the input screen on a displaying part of the terminal;
extracting, in response to receipt of request intensity levels associated with one or more object items designated by an input part of the terminal, one or more suitable solutions from the plurality of solutions based on the received request intensity levels and the at least one fitness value associated with the one or more object items registered in the database.

9. The method as claimed in claim 8, wherein the extraction step comprises associating a weight value with each of the request intensity levels, in response to receipt of the request intensity levels associated with the one or more object items designated by the input part of the terminal, for each of the one or more object items, multiplying the weight value associated with the respective request intensity level by the corresponding fitness value registered in the database, computing a sum of the multiplied products corresponding to the one or more object items for each of the plurality of solutions, and extracting the one or more suitable solutions from the plurality of solutions in ascending order with respect to the sums corresponding to the plurality of solutions.

10. The method as claimed in claim 8, further comprising a step of:
resetting the fitness values associated with the plurality of object items registered in the database.

11. The method as claimed in claim 10, wherein the resetting step depends on whether the extracted one or more solutions have been accepted.

12. The method as claimed in claim 11, further comprising steps of:
forming a proposal screen including the extracted one or more solutions and choices for accepting the corresponding extracted solutions; and
sending the proposal screen to the terminal and displaying the proposal screen on a display part of the terminal,
wherein the resetting step, when the terminal adopts the extracted one or more solutions, comprises resetting the fitness values in such a way that the acceptance is reflected.

13. The method as claimed in claim 11, wherein the resetting step comprises resetting the fitness values based on deviation scores.

14. The method as claimed in claim 13, wherein the resetting step comprises computing standard deviations at time of resetting the fitness values, and when any of the standard deviations is not less than or equal to a predetermined value, calling an alert.

15. A recording medium for storing a program to cause a computer to execute a procedure of extracting a solution for a system having a terminal and a server wherein the terminal includes a display part and an input part and a server apparatus is connected to the terminal via a network and includes a database configured such that at least one fitness value is associated with each of the plurality of the object items for each of a plurality of solutions, the procedure comprising steps of:
forming an input screen including the plurality of object items and a predetermined number of choices for request intensity levels associated with each of the plurality of object items;
sending the input screen to the terminal and displaying the input screen on the displaying part of the terminal;
extracting, in response to receipt of request intensity levels associated with one or more object items designated by the input part of the terminal, one or more suitable solutions from the plurality of solutions based on the received request intensity levels and the at least one fitness value associated with the one or more object items registered in the database.

16. The recording medium as claimed in claim 15, wherein the extraction step comprises associating a weight value with each of the request intensity levels, in response to receipt of the request intensity levels associated with the one or more object items designated by the input part of the terminal, for each of the one or more object items, multiplying the weight value associated with the respective request intensity level by the corresponding fitness value registered in the database, computing a sum of the multiplied products corresponding to the one or more object items for each of the plurality of solutions, and extracting the one or more suitable solutions from the plurality of solutions in ascending order with respect to the sums corresponding to the plurality of solutions.

17. The recording medium as claimed in claim 15, wherein the procedure further comprises a step of:
resetting the fitness values associated with the plurality of object items registered in the database.

18. The recording medium as claimed in claim 17, wherein the resetting step depends on whether the extracted one or more solutions have been accepted.

19. The recording medium as claimed in claim 18, wherein the procedure further comprises steps of:
forming a proposal screen including the extracted one or more solutions and choices for accepting the corresponding extracted solutions; and
sending the proposal screen to the terminal and displaying the proposal screen on a display part of the terminal,
wherein the resetting step, when the terminal adopts the extracted one or more solutions, comprises resetting the fitness values in such a way that the acceptance is reflected.

20. The recording medium as claimed in claim 18, wherein the resetting step comprises resetting the fitness values based on deviation scores.

21. The recording medium as claimed in claim 20, wherein the resetting step comprises computing standard deviations at time of resetting the fitness values, and when any of the standard deviations is not less than or equal to a predetermined value, calling an alert.
